(19) United States
(12) Patent Application Publication
(10) Pub. No.: US 2019/0257969 A1
(43) Pub. Date: Aug. 22, 2019

(54) NODE DEPLOYMENT USING DEFLECTORS

(71) Applicant: PGS Geophysical AS, Oslo (NO)

(72) Inventor: Einar Nielsen, Oslo (NO)

(73) Assignee: PGS Geophysical AS, Oslo (NO)

(21) Appl. No.: 16/257,415

(22) Filed: Jan. 25, 2019

Related U.S. Application Data
(60) Provisional application No. 62/632,543, filed on Feb. 20, 2018.

(51) Int. Cl. G01V 1/38; B63B 21/56

(52) U.S. Cl. CPC G01V 1/3852; B63B 2021/566; B63B 21/56

(57) ABSTRACT

Ocean-bottom node deployment is provided. An example system includes a pulley system which includes a pulley, a traction wheel on a marine vessel and a transport line looped around the pulley and the traction wheel. A plurality of release units are coupled to the transport line at spaced intervals and are configured to selectively secure and release a plurality of ocean-bottom nodes connected respectively thereto. A deflector connects to the pulley system and is configured to position the pulley system relative to the marine vessel. A central control unit is communicatively coupled to the plurality of release units and to the deflector and the traction wheel and includes a central processor. The central processor controls positioning of the pulley system with the deflector and commands each of the plurality of release units to release each of the plurality of ocean-bottom nodes at a predefined position.

### CROSS-REFERENCE TO RELATED APPLICATIONS

This application claims the benefit of U.S. Provisional Application Ser. No. 62/632,543 filed Feb. 20, 2018 titled “Node Deployment Using Deflectors.” The provisional application is incorporated by reference herein as if reproduced in full below.

### BACKGROUND

Marine geophysical data recording, in particular seismic data recording, may be performed with “nodal” recorders used to acquire seismic or electromagnetic data regarding Earth formations below a body of water such as a lake or ocean. Nodal recorders or ocean-bottom nodes (OBN) are self-contained devices that are disposed at selected positions on the bottom of a body of water such as a lake or the ocean. An energy source deployed in the water is actuated at selected times and signals generated by sensors in the nodes are stored in a recording device associated with each node. Practical applications for node acquisition begin with accuracy of placement. Node placement is typically carried out with a planting frame or remotely operated vehicle (ROV).

Ocean-bottom nodes utilizing built-in navigation and trajectory control systems have also been developed to improve accuracy during placement operations. A node so equipped can be deployed from the surface and is capable of autonomously making lateral corrections to its position as it sinks to the bottom. Yet, such nodes may be more difficult to deploy in shallow water, for example, where the node does not have as much time to make large corrections laterally, given the depth of the water and the shorter time before the node reaches the bottom. Thus, a marine vessel deploying the nodes may need to move closer to the intended position of each node, making the process of deploying the nodes more time-consuming, especially if the nodes are to be deployed over a large area.

### BRIEF DESCRIPTION OF THE DRAWINGS

For a detailed description of example embodiments, reference will now be made to the accompanying drawings in which:

FIG. 1 shows a top view of a system for ocean-bottom node deployment in accordance with at least some embodiments;

FIG. 2 shows a top view of a system for ocean-bottom node deployment in accordance with at least some embodiments;

FIG. 3 shows a block diagram of a system for ocean-bottom node deployment in accordance with at least some embodiments;

FIG. 4 shows a perspective view of a deflector and bridle of a system for ocean-bottom node deployment in accordance with at least some embodiments;

FIG. 5 shows a partial block diagram, partial elevation view of a deflector control system of a system for ocean-bottom node deployment in accordance with at least some embodiments;

FIG. 6 shows a loading operation of each of a plurality of ocean-bottom nodes from a marine vessel onto respective release units of a system for ocean-bottom node deployment in accordance with at least some embodiments;

FIG. 7 is another view of the loading operation of FIG. 6 in accordance with at least some embodiments;

FIG. 8 shows a transport line of a system for ocean-bottom node deployment extending outwardly from a marine vessel after one or more of a plurality of ocean-bottom nodes are loaded from the marine vessel onto respective release units in accordance with at least some embodiments;

FIG. 9 illustrates one of the plurality of ocean-bottom nodes being released by the release unit in accordance with at least some embodiments;

FIG. 10 illustrates one of the plurality of ocean-bottom nodes sinking in the water after being released by the release unit in accordance with at least some embodiments;

FIG. 11 shows the plurality of ocean-bottom nodes 22 after each has reached its respective resting position at the bottom of a body of water in accordance with at least some embodiments; and

FIGS. 12 and 13A-13B illustrate a method for ocean-bottom node deployment using deflectors in accordance with at least some embodiments.

### DEFINITIONS

Various terms are used to refer to particular system components. Different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to. . . .” Also, the term “couple” or “couples” is intended to mean either an indirect or direct connection. Thus, if a first device couples to a second device, that connection may be through a direct connection or through an indirect connection via other devices and connections.

“Cable” shall mean a flexible, load carrying member that also comprises electrical conductors and/or optical conductors for carrying electrical power and/or signals between components.

“Rope” shall mean a flexible, axial load carrying member that does not include electrical and/or optical conductors for carrying electrical power and/or signals between components. Such a rope may be made from fiber, steel, other high strength material, chain, or combinations of such materials.

“Line” shall mean either a rope or a cable.

“Substantially” shall mean, with respect to distance measures, a change of five percent (5%) or less of the distance.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

This disclosure is related generally to the field of marine surveying. Marine surveying can include, for example, seismic and/or electromagnetic (EM) surveying, among others. For example, this disclosure may have applications in marine surveying, in which one or more sources are used to generate wave-fields, and receivers—either towed or ocean bottom—receive energy generated by the sources and affected by interaction with subsurface formations. The receivers can take the form of ocean-bottom nodes (OBN). The present disclosure is related to deployment of ocean-bottom nodes using deflectors. More particularly, various example embodiments are directed to a vessel towing a deflector with a pulley system implemented between the vessel and the deflector. The pulley system is used to suspend a plurality of ocean-bottom nodes between the vessel and the deflector. When the ocean-bottom nodes are in the correct position (e.g., above a desired location on the sea floor) the ocean-bottom nodes are released from the pulley system and are thus allowed to sink to the sea floor. Having multiple ocean-bottom nodes along a pulley system enables simultaneous or near-simultaneous release, and also enables for more efficient placement in shallow water. The specification first turns to a description of an example system for ocean-bottom node deployment.

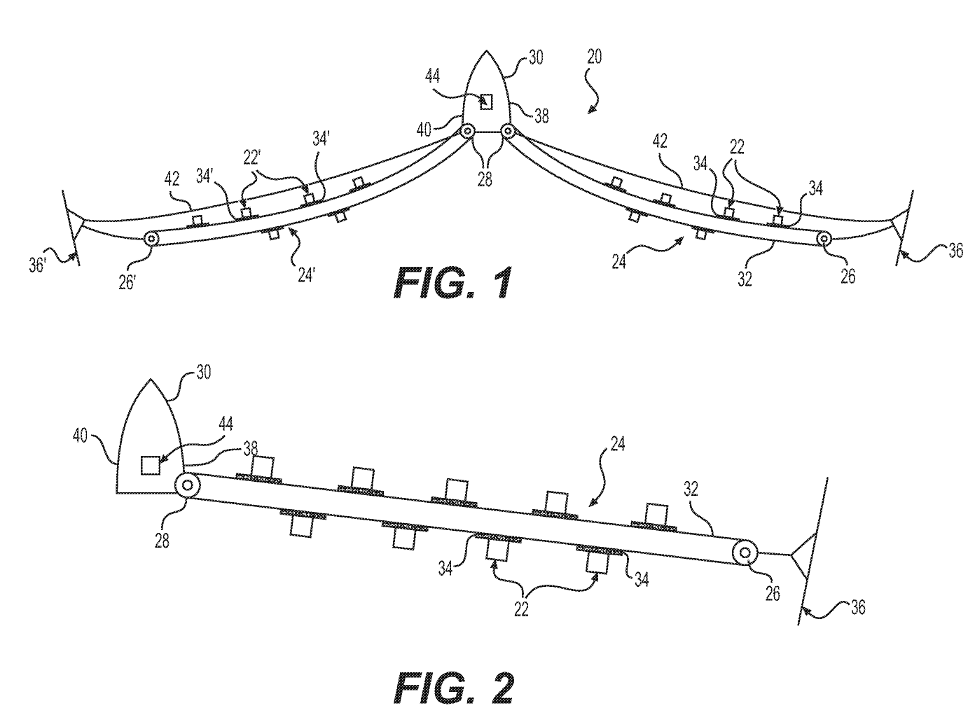

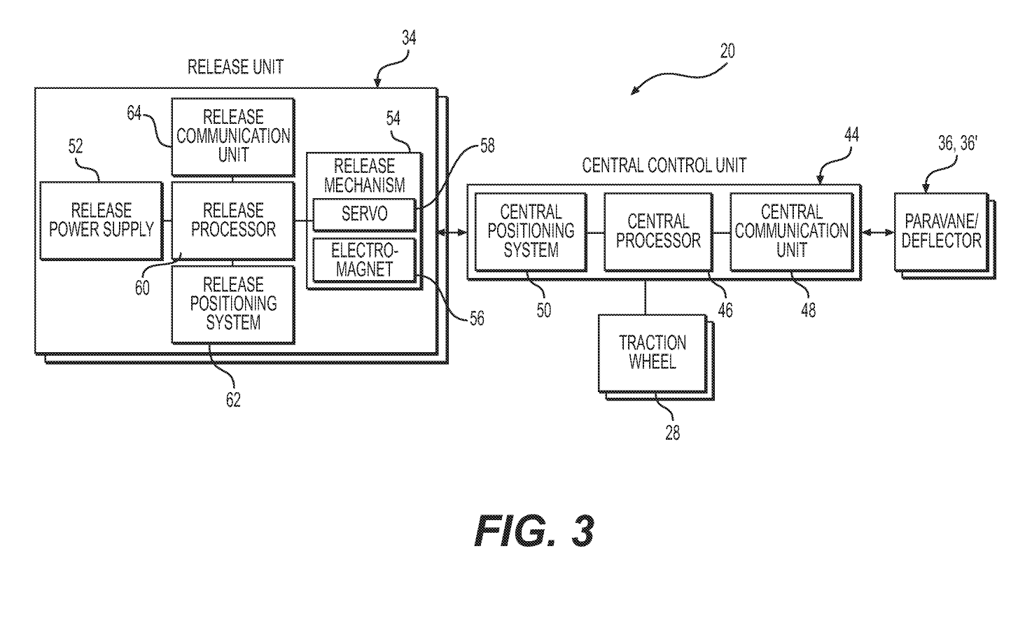

As shown in FIGS. 1 and 2, a system 20 for ocean-bottom node deployment is provided. The system 20 includes a pulley system 24 which includes a pulley 26, a traction wheel 28 disposed on a marine vessel 30 and a transport line 32 looped around the pulley 26 and the traction wheel 28. A plurality of release units 34 are coupled to the transport line 32 at spaced intervals and are configured to selectively secure and release a plurality of ocean-bottom nodes 22, respectively, connected thereto. In other words, the pulley system 24 can be used to deploy the ocean-bottom nodes 22 from the marine vessel 30.

A deflector 36 is connected to the pulley system 24 and configured to position the pulley system 24 relative to the marine vessel 30. In more detail, the deflector 36 is disposed remotely from the marine vessel 30 on a first side 38 of the marine vessel 30 and a second deflector 36′ may be disposed remotely from the marine vessel 30 on a second side 40 of the marine vessel 30 opposite the first side 38. The system 20 can also include a second pulley system 24′ including a second transport line 32′ extending between the second deflector 36′ and the marine vessel 30. The pulleys 26, 26′ are connected to respective deflectors 36, 36′. So as not to unduly complicate the description of the system 20, the system 20 will primarily be described below with reference only to deflector 36; nevertheless, it should be appreciated that the marine vessel 30 can deploy one or more deflectors 36, 36′ and pulley systems 24, 24′.

With reference to FIG. 1, a tow line 42 may be connected from the marine vessel 30 to the deflector 36; however, it should be understood that in some embodiments, no tow line 42 is utilized, and only the transport line 32 looped through the pulley 26 couples the deflector 36 to the traction wheel 28 on the marine vessel 30. Therefore, the deflector 36 can be towed by the transport line 32 and not by a tow line 42, as shown in FIG. 2. The specification now turns to overall conceptual organization of the system 20 according to at least some embodiments.

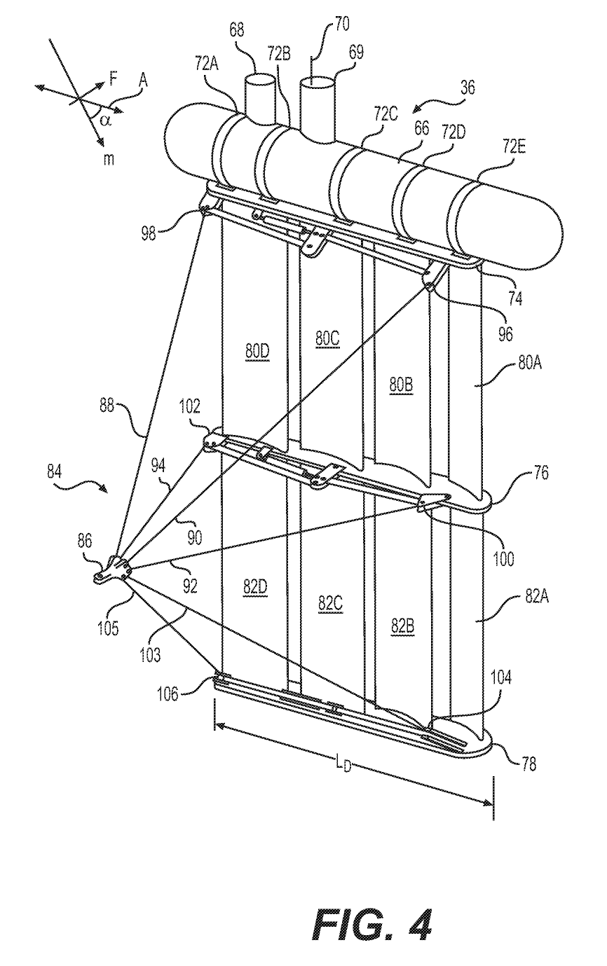

FIG. 3 shows a block diagram of a system for ocean-bottom node deployment in accordance with at least some embodiments. Example system 20 includes a central control unit 44 disposed on the marine vessel 30 (as shown in FIGS. 1 and 2) and communicatively coupled to the plurality of release units 34 and to the deflector 36 and the traction wheel 28. The central control unit 44 includes a central processor 46 configured to control positioning of the pulley system 24 with the deflector 36 and to command each of the plurality of release units 34 to release each of the plurality of ocean-bottom nodes 22, such as at a predefined position, at a predetermined time, or immediately upon receiving the command. The central processor 46 is coupled to a central communication unit 48. In addition, the central processor 46 is configured to determine a unit position of each of the plurality of release units 34 (e.g., along the transport line 32 and relative to the marine vessel 30, or a GPS position) and a deflector position of the deflector 36 (e.g., relative to the marine vessel 30, or a GPS position) and to determine the predefined position based on the unit position and the deflector position.

The central control unit 44 further includes a central positioning system 50 (e.g., a navigation system of the marine vessel 30) configured to determine a vessel position and a vessel speed of the marine vessel 30. So, the central processor 46 is further configured to determine a vessel position and a vessel speed of the marine vessel 30 using the central positioning system 50. In addition, the central processor 46 of the central control unit 44 can be further configured to control the traction wheel 28 to move the transport line 32 at a line speed based on the vessel speed of the marine vessel 30. However, it should be appreciated that in some embodiments, the transport line 32 could be moved by another mechanism besides or in addition to the traction wheel 28.

In the embodiment shown in FIG. 3, each of the plurality of release units 34 includes a release power supply 52 (e.g., a battery) and a release mechanism 54 powered by the release power supply 52 and configured to selectively couple to one of the plurality of ocean-bottom nodes 22. It should be understood that in some embodiments, power could alternatively or additionally be supplied to each of the plurality of release units 34 by one or more cables that couple to each of the plurality of release units 34. The release mechanism 54 of each of the plurality of release units 34 comprises an electromagnet 56 or a servomotor 58. It should be appreciated that other release mechanisms 54 may be utilized.

A release processor 60 is electrically coupled to the release mechanism 54 and is electrically coupled to and powered by the release power supply 52. Each release unit 34 also may include a release positioning system 62 coupled to the release processor 60 and configured to determine the unit position. Thus, the release processor 60 is further configured to monitor the unit position using the release positioning system 62. The release unit 34 can, for example, have global positioning system (GPS) capability to operate out of the water and an acoustic positioning unit to operate during times when the release unit 34 is submerged (e.g., as the release unit 34 approaches the deflector 36 remotely from the marine vessel 30). Furthermore, the release unit 34 could additionally include inertial guidance (e.g., a gyroscope, accelerometers) for determining the unit position during times that the release unit 34 is submerged, for instance.

Still referring to FIG. 3, each of the plurality of release units 34 also includes a release communication unit 64 coupled to the release processor 60 and configured to communicate with the central control unit 44. While the release communication unit 64 may communicate at times using radio frequency communication, such communication may not be effective during times when the release unit 34 is submerged, due to attenuation of electro-magnetic waves in water. Thus, the release communication unit 64 may also employ acoustic communication as well, so that the release units 34 can communicate with the central control unit 44, while they are submerged. In other embodiments, the release communication unit 64 can communicate with the central control unit 44 via a serial communication cable, for example. In some embodiments, the traction wheel 28 can be controlled by the central processor 46 using input from the release positioning system 62 of the release unit 34, for example, as well.

In operation, the release processor 60 is configured to receive a drop signal from the central control unit 44 using the release communication unit 64 and to release the one of the plurality of ocean-bottom nodes 22 using the release mechanism 54 in response to receiving the drop signal. Therefore, the release unit 34 can be controlled based on communication with the central control unit 44. For example, the release processor 60 can communicate the unit position to the central communication unit 48 using the release communication unit 64. When an ocean-bottom node 22 is in a predefined position along the pulley system 24, for instance, as determined by the central control unit 44 (e.g., based on the release communication unit 64 communicating the unit position to the central communication unit 48 of the central control unit 44), the release unit 34 can release the ocean-bottom node 22. In other embodiments, the central control unit 44 may determine when to send the drop signal using an inferred position of the release unit 34 on the transport line 32. Specifically, if the line speed, position of each particular release unit 34 on the transport line 32, and deflector position of the deflector 36 are known to the central control unit 44, the central control unit 44 could estimate when a particular release unit 34 reaches the predefined location and send the drop signal at that time (e.g., without receiving the unit position from the release unit 34). Alternatively or in addition, an indicator could be affixed to the transport line 32 and the position of such an indicator can be sensed by the central control unit 44 when it reaches a certain point on or near the marine vessel 30. Thus, because the positions of each release unit 34 are fixed on the transport line 32, the position of each ocean-bottom node 22 along the transport line 32 may be inferred by the central control unit 44 based on the position of the indicator and transport line 32 relative to the marine vessel 30.

While the drop signal sent from the central communication unit 48 of the central control unit 44 to the release communication unit 64 may lead to the release unit 34 dropping or releasing the ocean-bottom node 22 immediately after the release communication unit 64 receives the drop signal, it should be appreciated that, in other embodiments, the drop signal may not result in such an immediate release. In more detail, the drop signal could comprise a drop location (e.g., the predefined position at which the ocean-bottom node 22 should be released) and after the release communication unit 64 receives the drop signal, the release processor 60 may store the drop location and release the one of the plurality of ocean-bottom nodes 22 using the release mechanism 54 once the release positioning system 62 identifies that the release unit 34 has reached the drop location, or is within a predetermined drop radius of the drop location. The specification now turns to a detailed description of an example deflector 36 that may be used with at least some embodiments, to enable the central control unit 44 to control positioning of the pulley system 24.

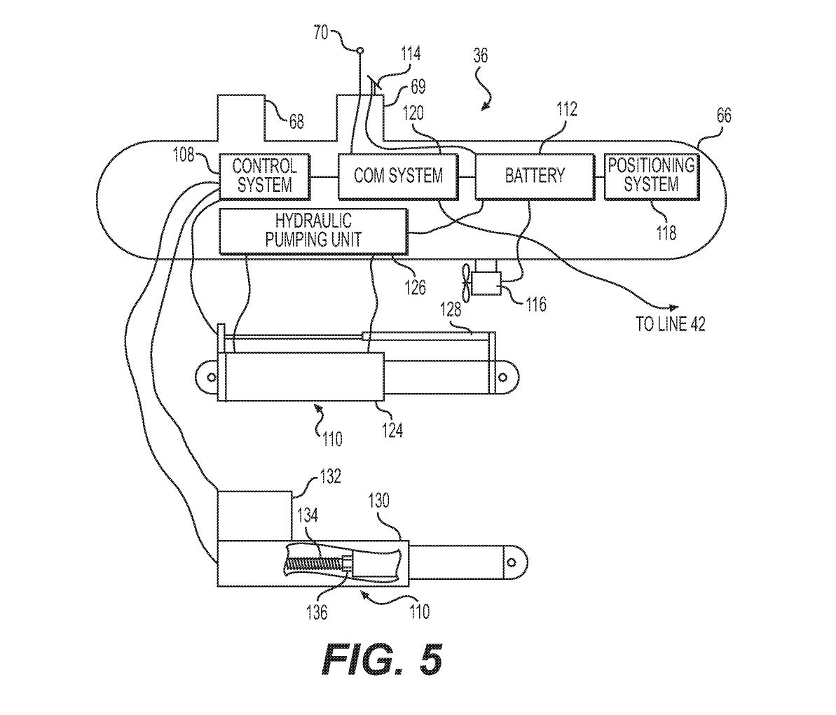

FIG. 4 shows a perspective view of a deflector 36 and bridle of a system for ocean-bottom node deployment in accordance with at least some embodiments. It is noted that the second deflector 36′ is, in some embodiments (and from a mechanical standpoint), a mirror image of the deflector 36 shown in FIG. 4; thus, the specification only discusses deflector 36 with the understanding that the discussion is equally applicable to the second deflector 36 taking into account the mirror symmetry. It should be understood that deflector 36 is only one example device that can be used with the system for ocean-bottom node 22 deployment discussed herein. The deflector 36 creates tension in the tow line 42 (and the pulley system 24) based on being towed through the water by the marine vessel 30, the tension roughly perpendicular to the direction of tow. Deflector 36 comprises a buoy or float 66, which provides a buoyant force for the deflector 36 during operation, and also fixes the orientation of the deflector 36 in the water. While in some cases the float 66 may reside at or near the surface of the water or may be partially submerged. In other embodiments, the float 66 may be fully submerged during operation. The amount of buoyant force provided by the float 66 may be adjustable (such as by filling ballast tanks). The float 66 may comprise one or more towers such as towers 68 and 69. The towers 68 and 69, if present, may provide a housing for one more control and/or communication systems, such as a control system to control location of the tow points and/or the bridle geometry (discussed more below), and/or a communication system over which to communicate with the marine vessel 30 engaged in the deployment (as illustrated by antenna 70). Illustrative float 66 couples to the balance of the deflector 36 by way of a plurality of straps 72A-E; however, other numbers of straps 72A-E, and other attachment mechanisms, may be used.

The deflector 36 further comprises an upper frame 74, to which the straps 72A-E are coupled. The illustrative deflector 36 also comprises a middle frame 76 and lower frame 78. Each of the frames 74, 76, 78 defines a long dimension, with the long dimension indicated as Lo in the figure. Coupled between upper frame 74 and the middle frame 76 are a plurality of upper diverter plates 80A-D. The illustrative deflector 36 further comprises a plurality of lower diverter plates 82A-D coupled between middle frame 76 and the lower frame 78. In some cases, the upper diverter plates 80A-D are separate mechanical elements from lower diverter plates 82A-D, and in other cases each diverter plate is a single element that extends through middle frame 76 (e.g., upper diverter plate 80A and lower diverter plate 82A may be a single unit extending through the middle frame 76). Greater or fewer diverter plates 80A-D, 82A-D may be equivalently used. The diverter plates 80A-D, 82A-D are designed in such a way as to re-direct water flow through the plates 80A-D, 82A-D such that a lateral force is developed. The diversion of water by the diverter plates 80A-D, 82A-D to create the force may be based on an angle a of the diverter plates 80A-D, 82A-D relative to the direction of water flow along the axis A. While the diverter plates 80A-D, 82A-D are shown as having a curvature or an airfoil-type cross-section, some or all the plates 80A-D, 82A-D may instead be flat, or the deflector 36 may include some combination of flat and curved diverter plates 80A-D, 82A-D.

It is noted that deflector 36, having three frames 74, 76, 78 and two sets of diverter plates 80A-D, 82A-D extending between the frames 74, 76, 78, is merely illustrative. The various embodiments may be equivalently implemented on deflectors 36 having only a single set of diverter plates 80A-D, 82A-D extending between two frames 74, 76 (e.g., just upper diverter plates 80A-D), as well as deflectors 36 having three or more sets of diverter plates (e.g., diverter plates 80A-D, 82A-D, and other sets below lower diverter plates 82A-D).

Before proceeding, it is noted that deflector 36 moves through the water at an angle a relative to the direction of travel. Consider the axis A of the float 66. The motion of the deflector 36 through the water indicated by arrow m forms an acute angle a with the axis A (e.g., along the long dimension LD of any frame). The precise angle a depends on a variety of factors, such as speed of the deflector 36 relative to the water, bridle geometry, and the amount of resistance to movement the deflector 36 presents. The force created is substantially perpendicular to the illustrative axis A, and also substantially normal to a plane defined by the diverter plates 80A-D, 82A-D, with the approximate direction indicated by arrow F. While the direction of movement of the deflector 36 may be at an acute angle a with respect to the illustrative axis A, the leading vertical geometry (e.g., diverter plates 80A, 82A) shall be considered “forward” for purposes of this specification and claims.

Continuing to refer to FIG. 4, the deflector 36 may be coupled to the transport line 32 and/or the tow line 42 (FIGS. 1 and 2) by way of a bridle assembly 84. In particular, the bridle assembly 84 comprises bridle tow point 86, to which the pulley 26 and/or the tow line 42 may couple. Between the bridle tow point 86 and the frames 74, 76, 78 reside a plurality of lines 88, 90, 92, 94, 103, 105. In particular, an upper-forward line 90 couples between the bridle tow point 86 and the upper forward tow point 96 coupled to the upper frame 74. An upper-aft line 88 couples between the bridle tow point 86 and upper aft tow point 98 coupled to the upper frame 74. A middle-forward line 92 couples between the bridle tow point 86 and the middle forward tow point 100 coupled to the middle frame 76. A middle-aft line 94 couples between the bridle tow point 86 and middle aft tow point 102 coupled to the middle frame 76. A lower-forward line 103 couples between the bridle tow point 86 and the lower forward tow point 104 coupled to the lower frame 78. And a lower-aft line 105 couples between the bridle tow point 86 and lower aft tow point 106 coupled to the lower frame 78.

In accordance with the illustrated embodiment, the amount of force developed by the deflector 36 is controllable during use (e.g., as the deflector 36 is towed through the water) by selective control of the location of the tow points 86, 96, 98, 100, 102, 104, 106 relative to the frames 74, 76, 78. For example: the location of the upper forward tow point 96 and the corresponding upper aft tow point 98 relative to the upper frame 74 may be changed (while the distance between the tow points 86, 100, 102, 104, 106 remains unchanged); the location of the location of the middle forward tow point 100 and the corresponding middle aft tow point 102 relative to the middle frame 76 may be changed (while the distance between the tow points 86, 96, 98, 104, 106 remains substantially unchanged); and/or the distance between the lower forward tow point 104 and the corresponding lower aft tow point 106 relative to the lower frame 78 may be changed (while the distance between the tow points 86, 96, 98, 100, 102 remains substantially unchanged). Changes in the location of the upper forward tow point 96, upper aft tow point 98 middle forward tow point 100, middle aft tow point 102, lower forward tow point 104, and lower aft tow point 106 relative to the frames 74, 76, and 78 may result in changes of an angle of attack of the diverter plates 80A-D, 82A-D. Consequently, a magnitude of the lateral force developed by the diverter plates 80A-D, 82A-D changes accordingly. For example, during turns the diverter plate with a short radius (e.g., 80A and 82A) may be adjusted to have its angle of attack increased to compensate for reduced relative velocity between the diverter plate 80A, 82A and the water (e.g., by moving the tow points aft), and the diverter plate with a larger radius (e.g., 80D and 82D) may have its angle of attack decreased to compensate for increased relative velocity between the diverter plate 80D, 82D and the water (e.g., by moving the tow points forward). Similarly, in operational situations where a cross-current exists relative to the intended direction of travel of the marine vessel 30, the angle of attack as between the diverter plates 80A-D, 82A-D may be adjusted to compensate. Now that the external structure of the example deflector 36 has been described, the specification now turns to an example control system for the deflector 36.

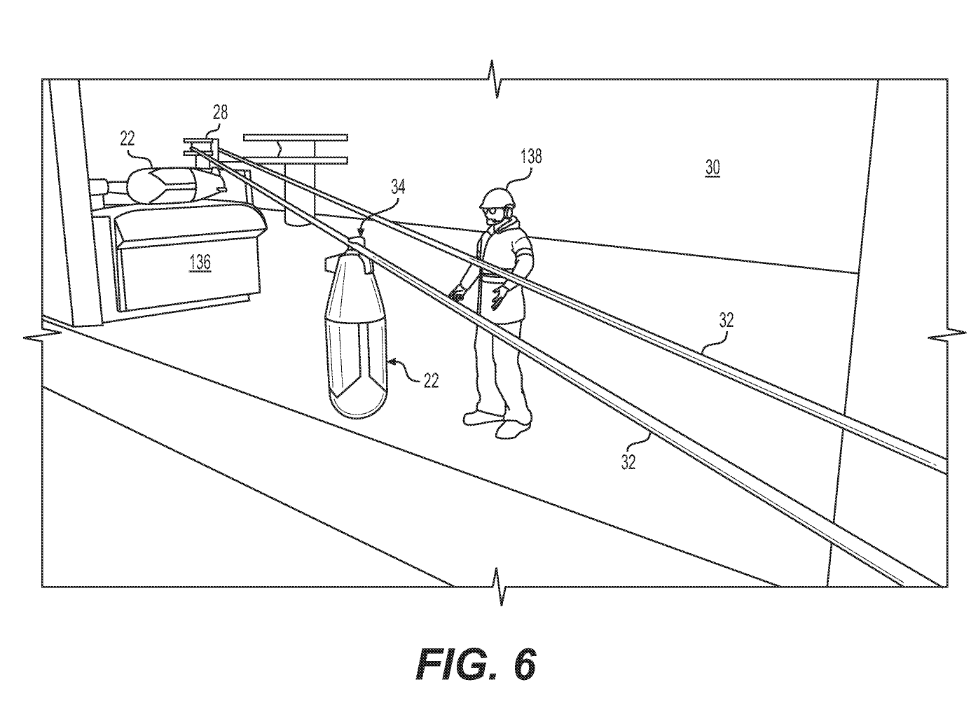

FIG. 5 shows a partial block diagram, partial elevation view of a deflector control system in accordance with at least some embodiments. In particular, FIG. 5 shows float 66, within which various components used for actuation of the linear actuator 110 may reside. For example, in a particular embodiment the deflector control system 108 may reside at least partially within the float 66, and in a particular embodiment within one of the illustrative towers 68, 69 of the float 66 (though not so illustrated in FIG. 5). The deflector control system 108 may be any suitable control system, such as a programmable logic controller (PLC) or dedicated computer system. The deflector control system 108 may derive power from a battery system 112, may derive power from the transport line 32 and/or the tow line 42 in the form of a cable as defined herein, or both. In some embodiments, the battery system 112 may be any suitable battery system 112, such as a set of lead-acid batteries. The battery system 112 may have sufficient power to perform all desired changes in length of the linear actuator(s) 110 (e.g., during an extended marine survey), or the battery system 112 may be charged during the survey by any suitable system, such as a solar panel 114 and/or electrical generator 116 that extracts energy from the water flowing past the deflector 36. The deflector 36 further includes a deflector positioning system (e.g., an acoustic positioning unit 118) for providing the deflector position of the deflector 36.

In order to know when to operate the linear actuator(s) 110, the deflector control system 108 may couple to a deflector communication unit (com system) 120. The deflector communication unit 120 may take any suitable form, such as a radio-based system communicating by way of antenna 70, or a system configured to communicate over electrical or optical conductors, such as when the tow line 42 coupled to the deflector 36 is a cable as defined herein. Regardless of the precise system implemented by the deflector communication unit 120, the deflector control system 108 may receive signals indicative of instructions to change the distance between respective sets of forward and aft tow points 96, 98, 100, 102, 104, 106 (i.e., respective sets being associated with a particular frame), and/or receive instructions to change the location of the tow points 96, 98, 100, 102, 104, 106). The deflector 36 may also utilize the deflector communication unit 120 to communicate the deflector position of the deflector 36 to the central control unit 44. So, for example, the traction wheel 28 may be controlled by the central processor 46 using input from the acoustic positioning unit 118 (or other deflector positioning system).

In the illustrative case of one or more of the linear actuator(s) 110 on the deflector 36 being a hydraulic cylinder 124, the system may comprise a hydraulic pumping unit 126 disposed at least partially within the float 66. In some cases, the hydraulic pumping unit 126 may draw operational power from the battery system 112, may draw operational power directly from the water flowing past the deflector 36, or some combination thereof. Regardless, the hydraulic pumping unit 126 may provide hydraulic fluid under high pressure to cause the axial length of the illustrative hydraulic cylinder 124 to change responsive to signals from the marine vessel 30 or some other location.

Still referring to FIG. 5, the system 20 may further comprise a linear sensor 128 associated with the linear actuator 110 in cases where precise axial length changes are desired. The linear sensor 128 may be any suitable linear sensing system, such as a linear potentiometer or linear Hall-effect sensor. It is noted that the term “linear sensor” 128 shall mean that the sensor measures axial distance of a linear actuator 110, and shall not require the sensors produce signals that, from a mathematical viewpoint, are linearly related to the axial length. For example, even a device that produces an exponentially increasing voltage signal based on axial length of a linear actuator 110 shall still be considered a “linear sensor” 128 for purposes of this specification and claims. Likewise, “linear actuator” 110 refers to a device with a controllable length, and shall not require that length be, from a mathematical viewpoint, linearly related to the control input.

As discussed above, the linear actuator(s) 110 need not be hydraulic cylinders 124. Other devices with controllable lengths may be equivalently used. For example, FIG. 5 also shows an electrically actuated linear actuator 130. The electrically actuated linear actuator 130 is shown in partial cut-away to illustrate the internal operation. An electrical motor 132 couples to a lead screw 134. The extension portion threadingly couples to the lead screw 134, such as an internally threaded nut 136. When the electric motor turns the lead screw 134, the extension portion is force out or drawn in, depending on the direction of the rotation of the lead screw 134. In some cases, a linear sensor 128 may be coupled to the exterior of the electrically actuated linear actuator 130 (e.g., linear sensor 128), and in other cases the electrically actuated linear actuator 130 may have an internal sensor which senses rotation of the lead screw 134 and thus the axial length.

Returning to FIGS. 1 and 2 briefly, the one or more deflectors 36, 36′ create tension in the tow line 42 and/or the transport line 32. Thus, the central control unit 44 can control positioning of the pulley systems 24, 24′ by adjusting the geometry of the bridle assembly 84 and consequently the angle of the diverter plates 80A-D, 82A-D. As described above, the central control unit 44 may communicate with the deflector communication unit 120 of the deflector 36 using the central communication unit 48. The diverter plates 80A-D, 82A-D can then be adjusted using the deflector control system 108 in response to the communication between the deflector 36 and the central control unit 44. Consequently, the plurality of release units 34 may be moved into a desired position for deployment of the plurality of ocean-bottom nodes 22, while proper tension is maintained in the tow line 42 and/or the transport line 32.

While the deflector 36 above is discussed as including adjustment of the geometry of the bridle assembly 84 relative to the diverter plates 80A-D, 82A-D, it should be understood that deflectors 36, 36′ with fixed vanes or diverter plates 80A-D, 82A-D and without adjustment of the geometry of the bridle assembly 84 can be utilized instead. Thus, instead of adjusting the diverter plates 80A-D, 82A-D using the deflector control system 108 to move the pulley system 24, 24′ and plurality of release units 34 into the desired position, in such an embodiment, the vessel speed of the marine vessel 30 may be varied to move the pulley system 24, 24′ into a desired position.

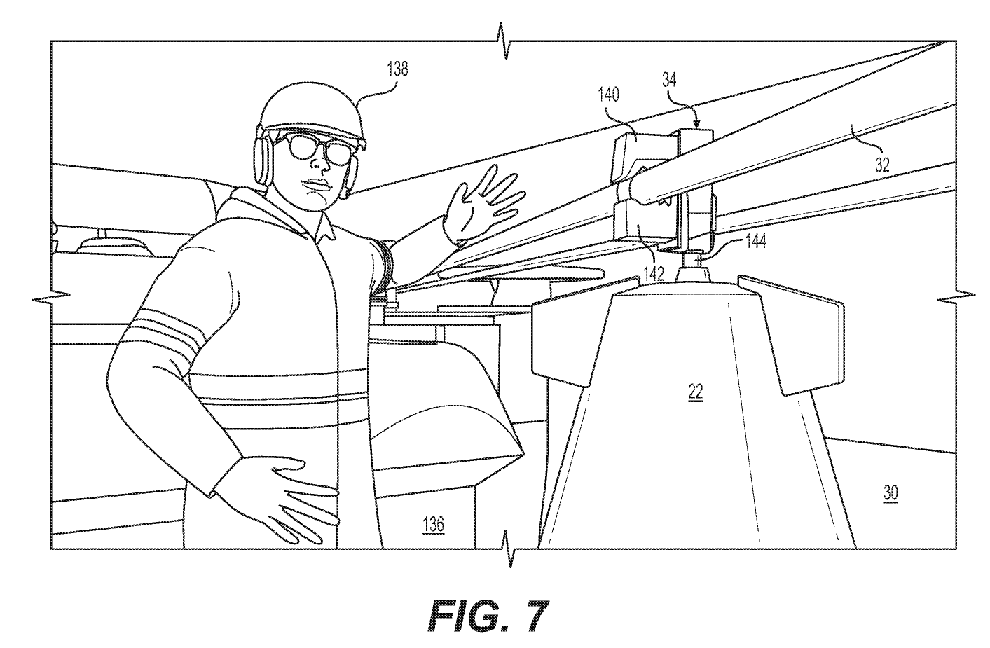

FIGS. 6-11 illustrate a sequence of deployment of ocean-bottom nodes 22 using deflectors 36, 36′ in accordance with at least some embodiments. More specifically, FIG. 6 shows a loading operation of each of the plurality of ocean-bottom nodes 22 from the marine vessel 30 onto respective release units 34. As shown, the traction wheel 28 is on the marine vessel 30 with the transport line 32 looped around the traction wheel 28. Each of the plurality of ocean-bottom nodes 22 is staged from a work platform 136 or table on the deck of the marine vessel 30 and may be removed as the transport line 32 moves around and presents one of the plurality of release units 34 ready for attachment to the respective ocean-bottom node 22. An operator 138 on the marine vessel 30 loads an ocean-bottom node 22 onto a release unit 34 as the transport line 32 moves around. Although the loading operation is shown as being carried out manually by the operator 138, it should be appreciated that the loading of the plurality of ocean-bottom nodes 22 may employ conveyors and/or automated loading mechanisms, without utilizing the operator 138, for example.

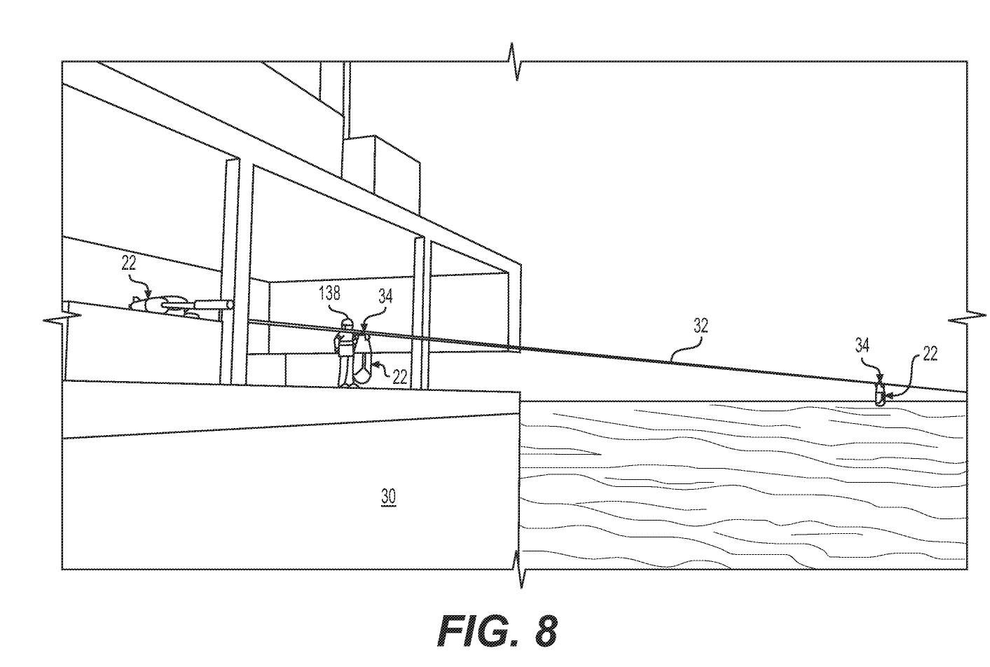

FIG. 7 is another view of the loading operation of each of the plurality of ocean-bottom nodes 22 from the marine vessel 30 onto respective release units 34. In this figure, an example of one of the plurality of release units 34 can be seen in more detail. Specifically, the release unit 34 clamps onto the transport line 32 using an upper jaw member 140 extending over the transport line 32 and a lower jaw member 142 extending under the transport line 32 opposite the upper jaw member 140. The release unit 34 releasably couples with the ocean-bottom node 22 via a pin 144 (only partially visible). Of course, other configurations of the release unit 34 are contemplated.

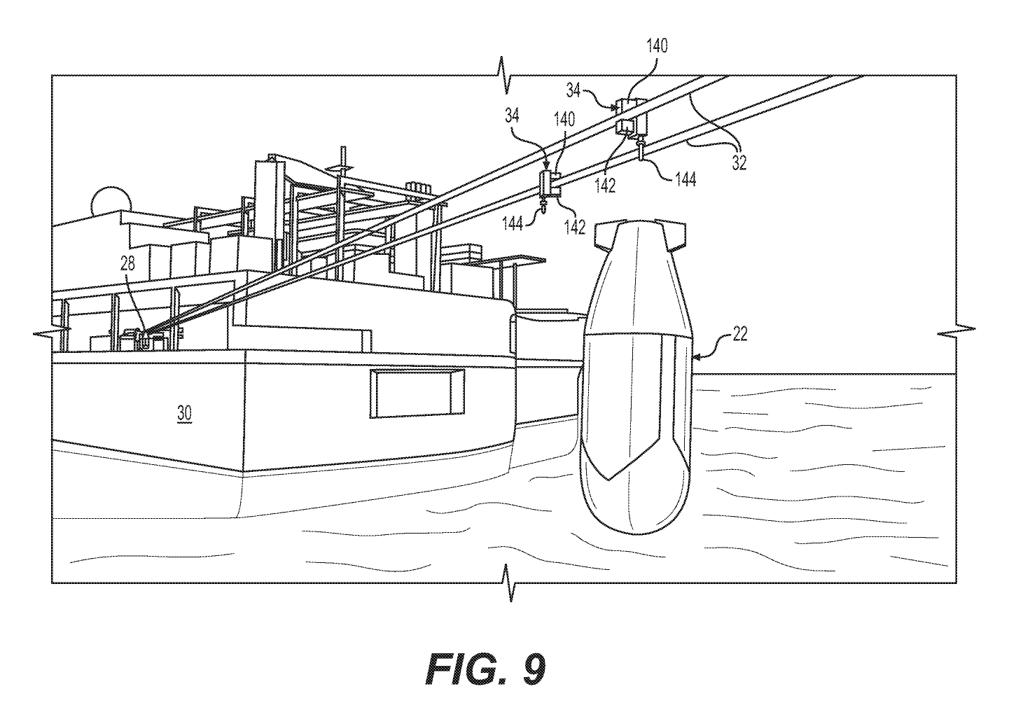

FIG. 8 shows a transport line 32 of the system 20 extending outwardly from the marine vessel 30 after one or more of the plurality of ocean-bottom nodes 22 are loaded from the marine vessel 30 onto respective release units 34. Each of the plurality of ocean-bottom nodes 22 and release units 34 are suspended above the water from the transport line 32 for periods of time as they travel outwardly from the marine vessel 30 toward the pulley 26 (not visible in FIG. 8) coupled to the deflector 36 (also not visible in FIG. 8). Thus, the transport line 32 may slant downwardly from the deck of the marine vessel 30.

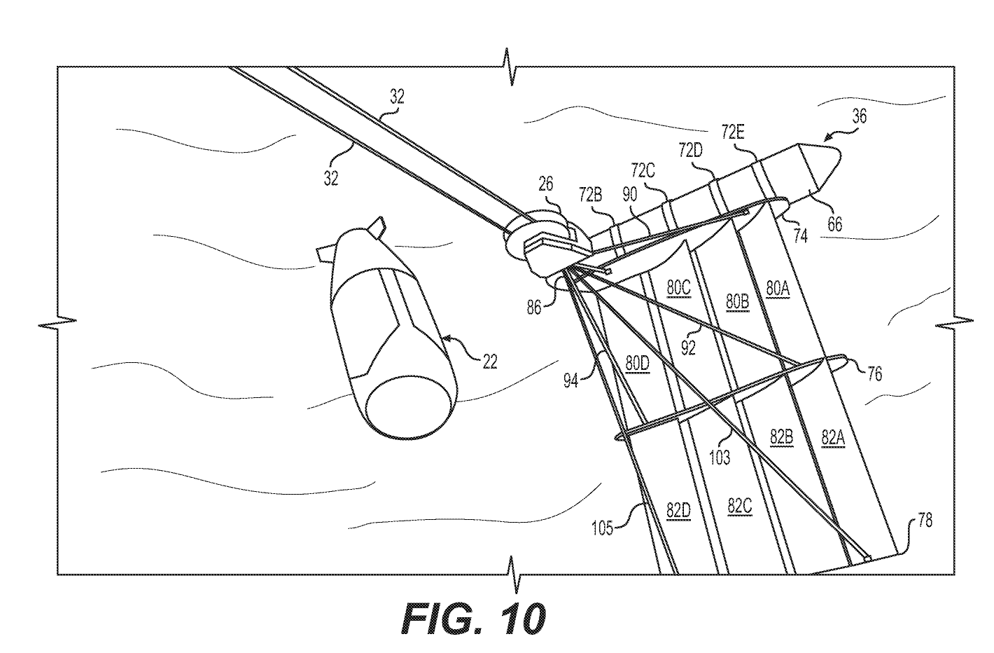

FIG. 9 illustrates one of the plurality of ocean-bottom nodes 22 being released by the release unit 34. Specifically, the one of the plurality of ocean-bottom nodes 22 slides from the pin 144 of the release unit 34 at the predefined position and drops into the water. While FIG. 9 shows the ocean-bottom node 22 being released above the surface of the water, it should be understood that the release unit 34 can alternatively release the ocean-bottom node 22 below the surface of the water.

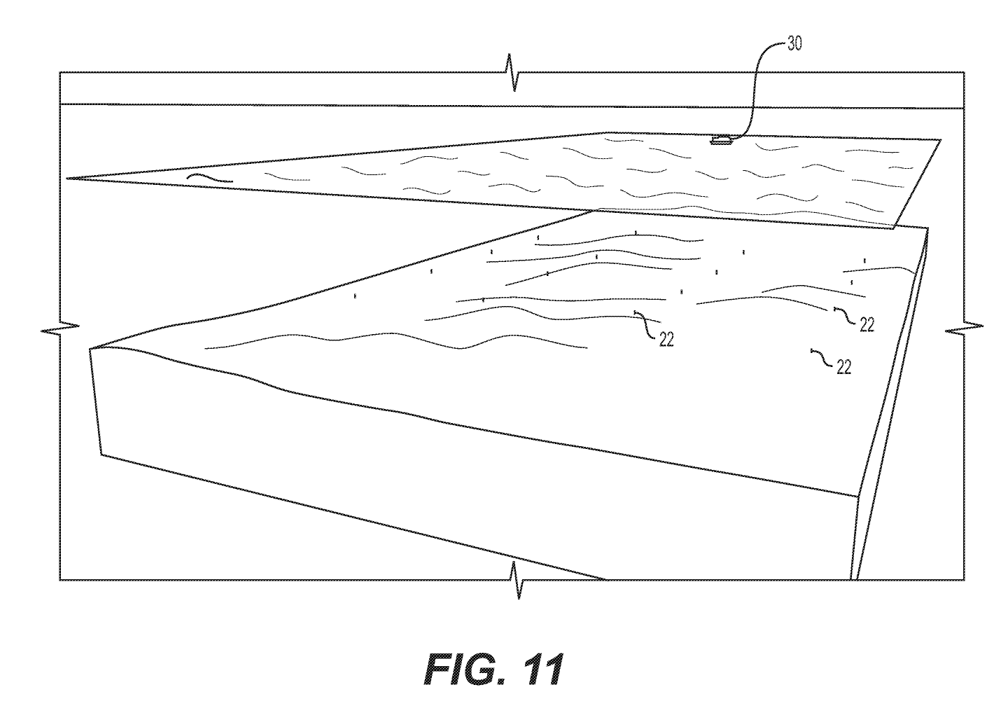

FIG. 10 illustrates one of the plurality of ocean-bottom nodes 22 sinking in the water after being released by the release unit 34. Also shown in FIG. 10 is the transport line 32 being looped around the pulley 26 of the pulley system 24, as well as the pulley 26 being coupled to the bridle tow point 86 of the deflector 36. In the example of FIG. 10, the deflector 36 is being towed by the transport line 32 and pulley 26.

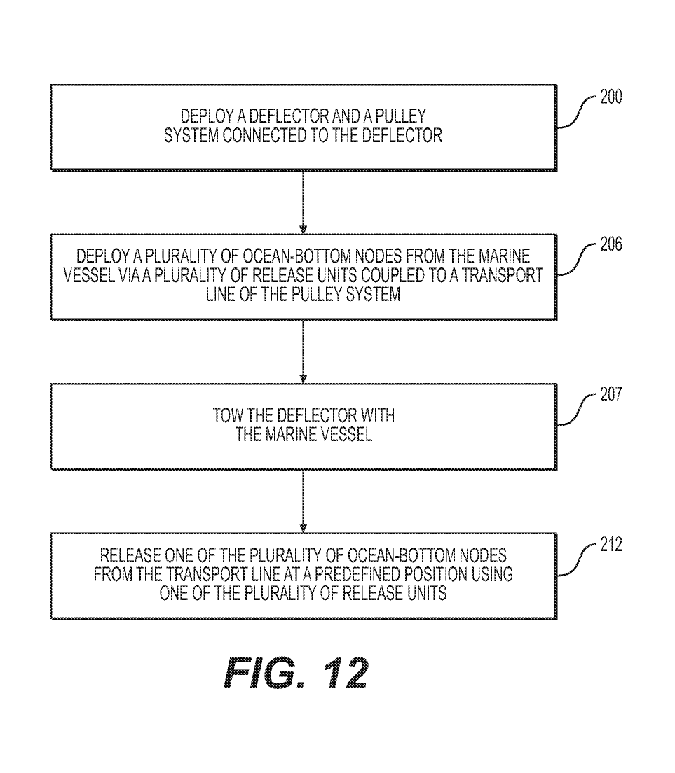

FIG. 11 shows a perspective, cut-away, view of the plurality of ocean-bottom nodes 22 after each has reached its respective resting position at the bottom of a body of water. The plurality of ocean-bottom nodes 22 are distributed over a large area on either side and behind the marine vessel 30 after the deployment is complete. So, the use of the deflectors 36, 36′ and pulley systems 24, 24′ of the system 20 (FIG. 1) described herein enables the deployment of the plurality of ocean-bottom nodes 22 more efficiently than if each of the plurality of ocean-bottom nodes 22 were deployed from the marine vessel 30 without the use of the deflectors 36, 36′ and pulley systems 24, 24′ of the system 20 (e.g., dropped over the side of the marine vessel 30 into the water one at a time).

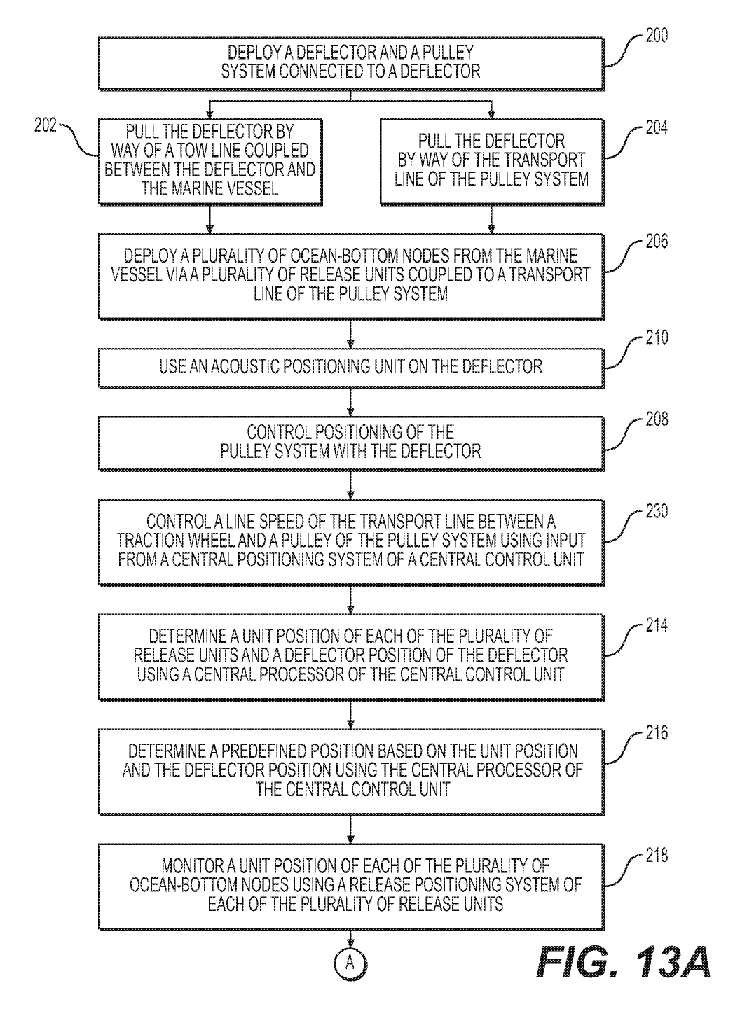

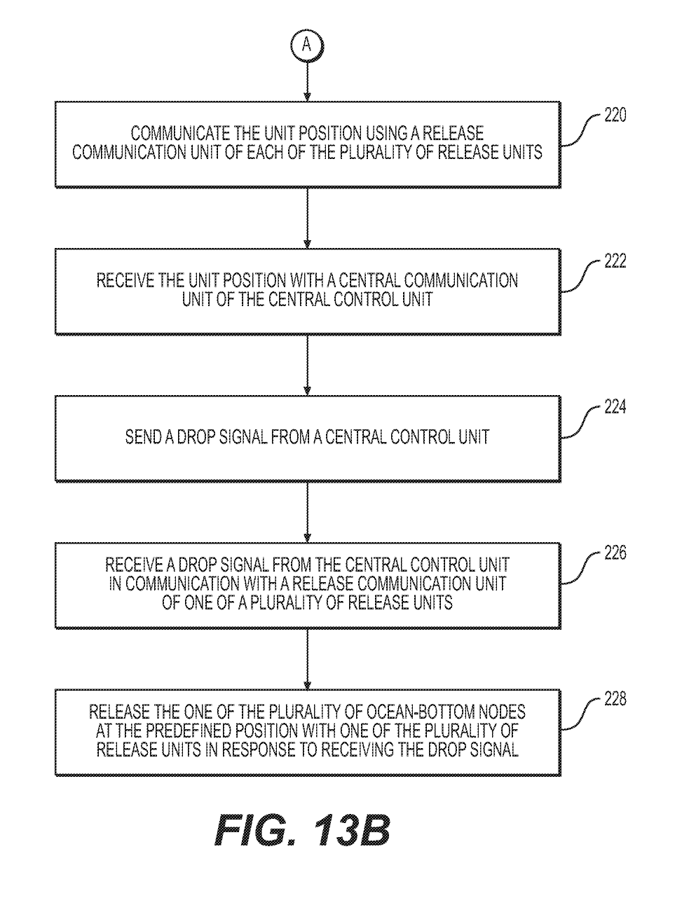

FIGS. 12 and 13A-13B illustrate a method for ocean-bottom node 22 deployment using the deflectors 36. The method includes the steps of 200 deploying a deflector 36 and a pulley system 24 connected to the deflector 36. Deploying the deflector 36 can include deploying the deflector 36 with a tow line 42 connected to the deflector 36. Thus, the method can include the step of 202 pulling the deflector 36 by way of a tow line 42 coupled between the deflector 36 and the marine vessel 30. Alternatively, deploying the deflector 36 can include deploying the deflector 36 without a tow line 42 connected to the deflector 36, so the method can include the step of 204 pulling the deflector 36 by way of the transport line 32 of the pulley system 24.

The method can proceed with the step of 206 deploying a plurality of ocean-bottom nodes 22 from the marine vessel 30 via a plurality of release units 34 coupled to a transport line 32 of the pulley system 24 (FIGS. 6-8). The method also includes the step of 207 towing the deflector 36 with the marine vessel 30. More specifically, towing the deflector 36 with the marine vessel 30 may comprise the step of 208 controlling positioning of the pulley system 24 with the deflector 36 (e.g., by adjusting the geometry of the bridle assembly 84 relative to the diverter plates 80A-D, 82A-D of the deflector 36). Controlling positioning of the pulley system 24 can also include the step of 210 using an acoustic positioning unit on the deflector 36.

Still referring to FIGS. 12 and 13A-13B, the method can proceed by 212 releasing one of the plurality of ocean-bottom nodes 22 from the transport line 32 at a predefined position using one of the plurality of release units 34 (FIGS. 9 and 10). The step of 212 releasing the one of the plurality of ocean-bottom nodes 22 can also include the steps of 214 determining a unit position of each of the plurality of release units 34 and a deflector position of the deflector 36 using a central processor 46 of a central control unit 44 and 216 determining the predefined position based on the unit position and the deflector position using the central processor 46 of the central control unit 44.

More specifically, 214 determining a unit position of each of the plurality of release units 34 and the deflector position of the deflector 36 can include the steps of 218 monitoring a unit position of each of the plurality of ocean-bottom nodes 22 using a release positioning system 62 of each of the plurality of release units 34 and 220 communicating the unit position using a release communication unit 64 of each of the plurality of release units 34. The method can continue by 222 receiving the unit position with a central communication unit 48 of the central control unit 44 and 224 sending a drop signal from a central control unit 44. Then, the next steps of the method are 226 receiving a drop signal from a central control unit 44 in communication with a release communication unit 64 of one of the plurality of release units 34 and 228 releasing the one of the plurality of ocean-bottom nodes 22 at the predefined position with one of the plurality of release units 34 in response to receiving the drop signal. The method may also include the step of 230 controlling a line speed of the transport line 32 between a traction wheel 28 and a pulley 26 of the pulley system 24 using input from a central positioning system 50 of the central control unit 44.

Advantages of the the inventive systems and methods can include providing the ability to deploy multiple ocean-bottom nodes 22 on transport lines 32 simultaneously from one marine vessel 30 to quickly and efficiently deploy the plurality of ocean-bottom nodes 22 over a large area (FIG. 11), even in shallow water. For example, six transport lines 32 may be deployed simultaneously. One marine vessel 30 can be used for both handling of the ocean-bottom nodes 22 and as a source vessel. Node operation efficiency can be improved by several factors using the self-positioning arrangement described herein for deploying the ocean-bottom nodes 22.

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the inventive systems and methods have been described herein, but embodiments may provide some, all, or none of such advantages, or may provide other advantages.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for ocean-bottom node deployment, comprising:
deploying a deflector and a pulley system connected to the deflector;
deploying a plurality of ocean-bottom nodes from a marine vessel via a plurality of release units coupled to a transport line of the pulley system;
towing the deflector with the marine vessel; and
releasing one of the plurality of ocean-bottom nodes from the transport line using one of the plurality of release units.

2. The method of claim 1, wherein towing the deflector with the marine vessel comprises pulling the deflector by way of a tow line coupled between the deflector and the marine vessel.

3. The method of claim 1, wherein towing the deflector with the marine vessel comprises pulling the deflector by way of the transport line of the pulley system.

4. The method of claim 1, wherein releasing the one of the plurality of ocean-bottom nodes comprises:
receiving a drop signal from a central control unit in communication with a release communication unit of one of the plurality of release units; and
releasing the one of the plurality of ocean-bottom nodes with one of the plurality of release units in response to receiving the drop signal.

5. The method of claim 1, further comprising controlling a line speed of the transport line between a traction wheel and a pulley of the pulley system using input from a central positioning system of a central control unit.

6. The method of claim 1, wherein towing the deflector with the marine vessel comprises controlling positioning of the pulley system with the deflector.

7. The method of claim 6, wherein controlling positioning of the pulley system comprises using an acoustic positioning unit on the deflector.

8. The method of claim 1, wherein releasing one of the plurality of ocean-bottom nodes from the transport line using one of the plurality of release units further comprises:
determining a unit position of each of the plurality of release units and a deflector position of the deflector using a central processor of a central control unit; and
generating a drop signal based on the unit position and the deflector position using the central processor of the central control unit.

9. The method of claim 8, wherein determining a unit position of each of the plurality of release units and the deflector position of the deflector comprises:
monitoring a unit position of each of the plurality of ocean-bottom nodes using a release positioning system of each of the plurality of release units;
communicating the unit position using a release communication unit of each of the plurality of release units; and
receiving the unit position with a central communication unit of the central control unit.

10. A system for ocean-bottom node deployment, comprising:
a pulley system including:
a pulley;
a traction wheel disposed on a marine vessel;
a transport line looped around the pulley and the traction wheel; and
a plurality of release units coupled to the transport line at spaced intervals, the plurality of release units configured to selectively secure and release a plurality of ocean-bottom nodes connected respectively thereto; and
a deflector connected to the pulley system being towed by the marine vessel.

11. The system of claim 10, further comprising a central processor configured to determine a unit position of each of the plurality of release units and a deflector position of the deflector and to generate a drop signal based on the unit position and the deflector position.

12. The system of claim 10, wherein the deflector further includes an acoustic positioning unit.

13. The system of claim 10, wherein the deflector is configured to position the pulley system relative to the marine vessel.

14. The system of claim 10, wherein each of the plurality of release units comprises:
a release power supply; and
a release mechanism powered by the release power supply and configured to selectively couple to one of the plurality of ocean-bottom nodes.

15. The system of claim 14, wherein each of the plurality of release units further comprises:
a release communication unit configured to communicate with a central control unit;
a release processor electrically coupled to the release mechanism and the release communication unit and electrically coupled to and powered by the release power supply and configured to:
receive a drop signal from the central control unit using the release communication unit, and
release the one of the plurality of ocean-bottom nodes using the release mechanism in response to receiving the drop signal.

16. The system of claim 15, wherein each of the plurality of release units further comprises a release positioning system coupled to the release processor and configured to determine the unit position and wherein the release processor is further configured to:
monitor the unit position using the release positioning system, and
communicate the unit position to the central communication unit using the release communication unit.

17. The system of claim 14, wherein the release mechanism of each of the plurality of release units comprises an electromagnet or a servomotor.

18. The system of claim 10, further including a tow line connected from the marine vessel to the deflector.

19. The system of claim 10, wherein the central control unit further includes a central positioning system configured to determine a vessel position and a vessel speed of the marine vessel and the central processor is further configured to determine a vessel position and a vessel speed of the marine vessel using the central positioning system.

20. The system of claim 19, wherein the central processor of the central control unit is further configured to control the traction wheel to move the transport line at a line speed based on the vessel speed of the marine vessel.

21. The system of claim 10, further including a second deflector, wherein the deflector is disposed remotely from the marine vessel on a first side of the marine vessel and the second deflector is disposed remotely from the marine vessel on a second side of the marine vessel opposite the first side.

22. The system of claim 21, further including a second pulley system including a second transport line extending between the second deflector and the marine vessel.
